(19) United States
(12) Patent Application Publication
(10) Pub. No.: US 2026/0117670 A1
(43) Pub. Date: Apr. 30, 2026

(54) PREVENTING ASYNCHRONOUS ROTATION IN AIRCRAFT COMPONENTS WITH RETROREFLECTORS

(71) Applicant: General Electric Company, Evendale, OH (US)

(72) Inventors: Phillip Schultz, Cincinnati, OH (US); Robert Kellerman, Morrow, OH (US); Brandon Kinzer, Cincinnati, OH (US)

(21) Appl. No.: 18/926,927

(22) Filed: Oct. 25, 2024

(51) Int. Cl. F01D 21/00

(52) U.S. Cl. CPC F01D 21/003; F05D 2220/323; F05D 2270/02; F05D 2270/804; F05D 2270/809

(57) ABSTRACT

A system for preventing asynchronous rotation in aircraft components includes an optical emitting source, an optical receiver, and a retroreflector configured to be disposed on a rotating component connected to an engine of an aircraft. The system emits radiant flux from the optical emitting source towards the retroreflector when the retroreflector is on the rotating component and the engine positions the rotating component into a field of view of the optical emitting source; receives incident radiant flux from the retroreflector by the optical receiver when the retroreflector is within the field of view of the optical emitting source; records a time of receiving the incident radiant flux; determines a rotational speed of the rotating component based on the recorded time; determines whether the rotational speed is within a predetermined range; and selectively changes a state of the engine when the rotational speed is outside of the predetermined range.

### TECHNICAL FIELD

This disclosure relates to engine fan blade abnormalities, and, more particularly, to preventing asynchronous rotation of components of an aircraft.

### BACKGROUND

Once-per-revolution (“one-per-rev”) is a term often used in reference to rotating machinery components, such as engines and turbines. One-per-rev refers to a signal that occurs once per revolution of the rotating component. For example, one-per-rev may be a vibration or another signal type which occurs only once per revolution of the rotating component. Thus, one-per-rev may be used to indicate a frequency, rotational speed, or the like. One-per-rev may be used to diagnose imbalances, misalignments, or wear in rotating machinery and ensure that functions of the rotating machinery are synchronized. By monitoring one-per-rev, inefficiencies in the rotating machinery may be reduced and risks of failure mitigated, as mechanical issues may be addressed before escalating out of control.

Sensors such as tachometers, which measure the rotational speed of machinery and provide a reference signal corresponding to one revolution, accelerometers, which measure signals corresponding to vibrations occurring once per revolution, proximity probes, which measure the distance between the probe and the rotating component, and encoders or transducers, which generate a pulse signal to provide measurements of rotational positioning, may be used to monitor one-per-rev. However, these sensors are sensitive to temperature variations, external magnetic fields, and other environmental conditions, which could cause inaccurate readings or degrade performance. Further, wear on sensors may lead to false readings. For example, in high-vibration environments, sensors may be apt to dislodge, and sensors such as tachometers which require contact with rotating components may be prone to physical damage. Sensors may also be required to be in close proximity to the measured component, and inconsistencies in distance between the sensor and the measured component may result in inaccuracies. Further, signal processing issues may occur at low rotational speeds. Generally, environmental and operational sensitivities often lead to mismeasurements in one-per-rev, increasing a risk of asynchronization and/or misalignment in rotating machinery components.

### BRIEF DESCRIPTION OF THE DRAWINGS

A better understanding of the features and advantages of the disclosed technology will be obtained by reference to the following detailed description that sets forth illustrative aspects, in which the principles of the technology are utilized, and the accompanying drawings of which:

FIG. 1 is a perspective view of a portion of an engine of an aircraft having a system for preventing asynchronous rotation of aircraft components, the view illustrating an optical emitting source, an optical receiver, and a retroreflector of the system, in accordance with an aspect of this disclosure;

FIG. 2A is a schematic view illustrating the retroflector of the system of FIG. 1 interacting with the optical emitting source and the optical receiver of the system of FIG. 1, with the optical emitting source and the optical receiver mounted within a housing of the engine;

FIG. 2B is a schematic view illustrating the retroflector of the system of FIG. 1 interacting with the optical emitting source and the optical receiver of the system of FIG. 1 via an optics housing;

FIG. 3 is a block diagram of a controller of the system of FIG. 1; and

FIG. 4 is a flow diagram of a method for preventing asynchronous rotation of aircraft components for use with the system of FIG. 1.

### DETAILED DESCRIPTION

Aspects of the presently disclosed system for detecting fan blade deflection are described in detail with reference to the drawings, in which like reference numerals designate identical or corresponding elements in each of the several views.

Although this disclosure will be described in terms of specific aspects, it will be readily apparent to those skilled in this art that various modifications, rearrangements, and substitutions may be made without departing from the spirit of this disclosure.

For the purpose of promoting an understanding of the principles of this disclosure, reference will now be made to exemplary aspects illustrated in the drawings, and specific language will be used to describe the same. It will nevertheless be understood that no limitation of the scope of this disclosure is thereby intended. Any alterations and further modifications of the features illustrated herein, and any additional applications of the principles of this disclosure, as illustrated herein, which would occur to one skilled in the relevant art and having possession of this disclosure, are to be considered within the scope of this disclosure.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” “generally,” and “substantially” is not to be limited to the precise value specified. In at least some instances, the approximating language may correspond to the precision of an instrument for measuring the value, or the precision of the methods or the machines for constructing the components and/or the systems or manufacturing the components and/or the systems. For example, the approximating language may refer to being within a one, two, four, ten, fifteen, or twenty percent margin in either individual values, range(s) of values and/or endpoints defining range(s) of values.

A one-per-rev measurement aids in synchronizing operation and measurement of rotating parts and determining a starting point on each rotating part. A common challenge in current systems for monitoring one-per-rev in rotating parts, such as aircraft engine parts, is sensor sensitivity to environmental factors and speed and bandwidth limitations of the sensor.

One manner of measuring one-per-rev is through use of a magnetic flux transducer. In this case, the rotating part includes a permanent magnet secured (e.g., embedded) at a specific circumference aligned with a feature of interest. For example, for a permanent magnet embedded within a hub of an engine, the magnet may be aligned with a blade of the engine. In theory, the magnetic flux transducer is configured to sense the magnetic field of the permanent magnet, that is, trigger a one-per-rev signal, upon the permanent magnet being brought into proximity of the magnetic flux transducer by rotation of the engine. However, in practice, a number of factors may lead to missed signals or inaccurate readings. Magnetic fields may be affected by ambient thermal effects, and further, at low rotational speeds, the magnetic flux transducer may fail to register any signal. Further, signal triggering may be limited to occur under a rotational speed or frequency limit, such as 200 rotations-per-minute (RPM).

To address the shortcomings of known sensors, an optical system using retroreflectors may be employed to provide a high-resolution, contactless measurement system for monitoring rotating components and therefore preventing asynchronous rotation of components. Retroreflectors are passive, optical reflectors designed to reflect radiant flux directly back to an optical emitting source from a wide range of incident angles with minimal scattering, regardless of the angle of incidence. In instances, retroreflectors may successfully reflect radiant flux at angles of about 60 degrees from a normal angle of incidence, and may do so omnidirectionally. The high intensity and consistent reflective properties provided by retroreflectors provide less constrained placement at a variety of angles and distances, and also permit higher resolution signal triggering, higher speed operation, and registration of rotational speeds down to zero RPM.

This disclosure provides a system for monitoring one-per-rev of a rotating component using a retroreflective element in order to determine a rotational speed of the rotating component and thereby prevent asynchronous rotation. For example, the system may be implemented into an engine of an aircraft (e.g., an aerial vehicle). An optical emitting source (transducer/emitter) emits radiant flux toward a rotating component, such as a hub of an engine, a portion of which includes a retroreflector disposed thereon. The emitted radiant flux is directed and transmitted from any appropriate location to be within line of sight and an appropriate incident angle of the retroreflector (e.g., direct, beam steering, waveguide transmitted, etc.) when the rotating component rotates to place the retroreflector within a field of view of the emitted radiant flux. When the retroreflector is in line with the emitted radiant flux, the emitted radiant flux is incident upon the retroreflector, leading to incident radiant flux being reflected back toward the optical emitting source. With an optical receiver (e.g., an optical detecting transducer and/or optical detector) placed in close proximity to the emitter, a portion of the retroreflected radiant flux is incident on the optical receiver. The optical receiver transduces the incident radiant flux into an electrical signal indicating one-per-rev. The signal may then be analyzed to determine a rotational speed of the component, and therefore to determine whether the component is rotating at an acceptable speed and/or determine whether the component is rotating in time with other components. The signal may also be used to locate a starting point on the component.

Overall, the use of retroreflectors enables longer range measurement of deflection as compared to traditional methods. Retroreflectors offer consistent reflection back to the emitting source within a broad range of incident angles, reducing effort in implemented placement and alignment. Based on the materials used to fabricate, retroreflectors provide broad optical bandwidth for flexibility in choice of optical emitter source. Optical filters and/or coatings may also be implemented onto the retroreflector for applications where only specific bandwidths are desired. Retroreflector structures may be fabricated in a variety of sizes, standalone or arrayed, out of a rigid or flexible material. Typically, scaling these structures down to smaller dimensions enables fabrication of the retroreflector structures in arrays out of flexible and conformal film or sheeting materials allowing for conformal application to a variety of substrate materials and shapes.

Moreover, retroreflectors provide a variety of safety benefits during testing, development, and/or real-time use. The high-intensity reflective capabilities of retroreflectors permit long range measurement, allowing test equipment to be placed farther away from an aircraft engine and/or operating aircraft. This reduces the potential of injury from moving parts. In addition, retroreflectors may serve to alert individuals within the evaluation area of various moving components, thereby maintaining vigilance during operation when an individual must remain within a close distance to the operating site. For example, to evaluate components including retroreflectors, an individual may have a source of radiant flux aligned collinear with the individual's eyes (e.g., a forehead light, a flashlight held within close proximity to the viewing direction of the individual's eyes, a work light mounted behind the individual, etc.). Retroreflectors are optically efficient and therefore enable the use of lower power optical emitting sources which have output irradiances (power per unit area) less than the human eye's maximum permissible exposure (MPE), thus preventing retinal damage.

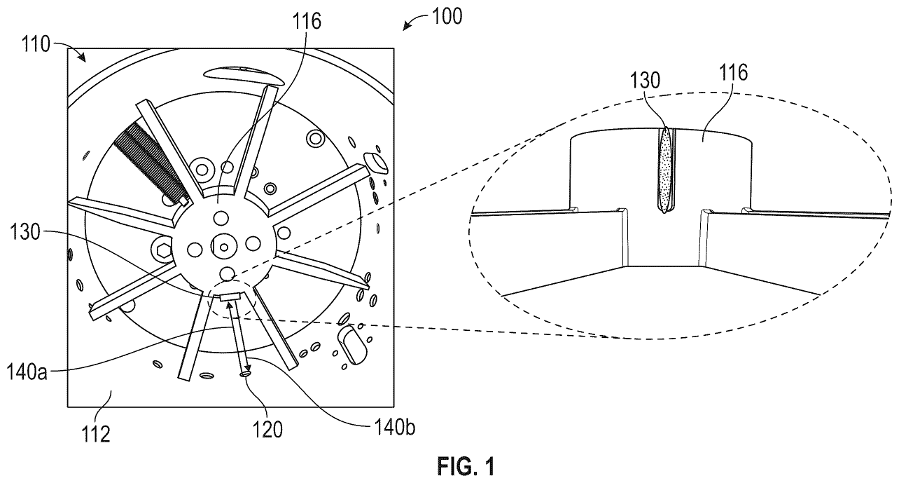

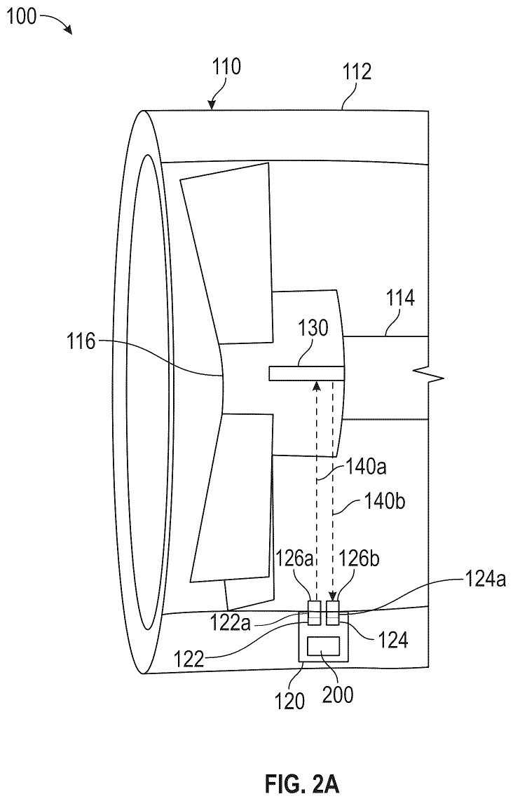

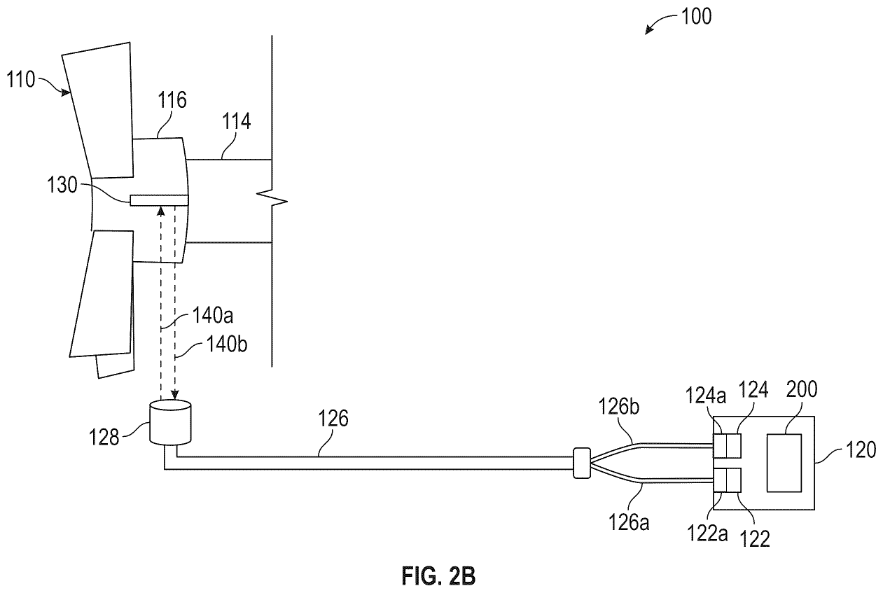

FIGS. 1, 2A, and 2B illustrate a system 100 for preventing asynchronous rotation of components using retroreflectors. In particular, system 100 may be used in rotating components of an aircraft, such as an engine 110 of an aircraft, to monitor and affect rotational speeds during testing and development and/or during in-flight operation for control system purposes. While engine 110 may be any suitable component configured for rotation, in the interest of brevity, the engine 110 is described herein in connection with an engine of an aircraft. Applications of system 100 towards fans, engines, and the like related to alternate vehicle types are contemplated as well.

System 100 generally includes an optical emitting source 122 configured to emit radiant flux (e.g., an optical emitter), a retroreflector 130 configured to be disposed on a rotating component of an aircraft and configured to be interrogated by the emitted radiant flux, an optical receiver 124 configured to receive the retroreflected radiant flux from the retroreflector 130 (e.g., an optical transduction device, an optical detector, or the like), and a controller 200 in communication with the optical emitting source 122, the optical receiver 124, and the rotating component of the aircraft. In aspects, the component of the aircraft is a portion of an engine 110 of the aircraft, particularly a shaft 114 or a hub 116 of the engine 110. The controller 200 is configured to determine one-per-rev of the engine 110 and/or engine component (e.g., the hub 116 or shaft 114), and therefore determine rotational speed, and may be configured to act as an optical emitter driver and to perform receiver signal conditioning, data acquisition, processing, and digital communications.

Both optical emitting source 122 and optical receiver 124 may be coupled to (e.g., included within) an electronics housing 120 (e.g., an emit-and-receive box). Electronics housing 120, and therefore optical emitting source 122 and optical receiver 124, may be configured to be disposed in any appropriate location within a line of sight to retroreflector 130 when the component upon which retroreflector 130 is disposed is rotated. For example, when engine 110 or a component thereof rotates to place retroreflector 130 in line with electronics housing 120. In aspects, when system 100 is implemented into an aircraft, electronics housing 120 may be configured to be disposed within a housing 112 or nacelle of engine 110, or on a pylon, a wing, undercarriage, chassis, or a fuselage of the aircraft.

Optical emitting source 122 may be, for example, a laser emitter. Optical emitting source 122 may have an optical power of between 0.1 to 1,000 milliwatts (mW), though other ranges are also contemplated. For example, depending upon optics used, optical emitting source 122 may have an optical power of less than 5 mW. The optical emitting source 122 may include a waveguide 126 which is coupled to an optical emitting transducer 122a. The waveguide 126 may be an optical fiber or optical fiber bundle, or may include a component configured to contain and transmit radiant flux from one end of the component to another. Optical emitting transducer 122a may generate radiant flux 140a which is transmitted via waveguide 126 toward retroreflector 130. In aspects, particularly for short-range applications, radiant flux 140a may be coupled into a waveguide 126 which transmits and emits radiant flux 140a into free space. For both short-and long-range applications, an optics housing 128 may be integrated at one or more ends of the waveguide 126. The optics housing 128 may be, or contain, one or more components used for radiant flux beam shaping (e.g., a collimator, lens, aperture, film, diffuser, axicon, refractive optic, diffractive optic, arrayed optic, etc.). In aspects, optics housing 128 may be used to shape, transmit, and emit radiant flux 140a from the waveguide 126 or optical emitting source 122. For applications which require differing spot sizes or shapes, an adjustable version of optics housing 128 may be used. Radiant flux 140a may be visible light having a wavelength between about 400 and 700 nanometers, near infrared radiation having a wavelength of about 700 to 1,400 nanometers, shortwave infrared radiation having a wavelength of about 900 to 1,700 nanometers, or may have any other suitable wavelength. Generally, radiant flux 140a may have a wavelength of about 400 to 1,600 nanometers.

As will be described in greater detail, upon engine 110 rotating and radiant flux 140a coming into a field of view of retroreflector 130, radiant flux 140a interrogates retroreflector 130, and incident radiant flux 140b is reflected toward optical receiver 124. Optical receiver 124 may include a waveguide 126 which is coupled to an optical detecting transducer 124a. The waveguide 126 coupled to optical detecting transducer 124a may be an optical fiber or optical fiber bundle, or may include a component configured to contain and transmit radiant flux from one end of the component to another. The waveguide 126 may be configured to receive incident radiant flux 140b and transmit incident radiant flux 140b to optical detecting transducer 124a which is configured to convert the incident radiant flux 140b to an electrical signal. In aspects, particularly for short-range applications, incident radiant flux 140b may be coupled into a waveguide 126 which receives and transmits incident radiant flux 140b from free space. For both short-and long-range applications, an optics housing 128 may be integrated at one or more ends of the waveguide 126. The optics housing 128 may be, or contain, one or more components used for radiant flux beam shaping (e.g. collimator, lens, aperture, film, diffuser, axicon, refractive optic, diffractive optic, arrayed optic, etc.). In aspects, optics housing 128 may be used to receive, shape, transmit, and couple incident radiant flux 140b into a waveguide 126 or optical receiver 124. For applications which require differing receiving or coupling efficiencies, an adjustable version of optics housing 128 may be used.

In aspects, an emitting cable may be assembled with one or more emitting waveguides 126a and a receiving cable may be assembled with one or more receiving waveguides 126b. In aspects, the one or more emitting waveguides 126a and the one or more receiving waveguides 126b may be integrated with one another into a single waveguide 126 bundle, where the one or more emitting waveguides 126a are separately coupled to the optical emitting source(s) 122 and the one or more receiving waveguides 126b are separately coupled to the optical receiver(s) 124. In aspects, the one or more emitting waveguides 126a and the one or more receiving waveguides 126b may be coupled to electronics housing 120. The one or more emitting waveguides 126a and the one or more receiving waveguides 126b may be contained within or coupled to electronics housing 120, and/or optical emitting transducer 122a and optical detecting transducer 124a may be contained within or coupled to electronics housing 120. In aspects, all components of optical emitting source 122 and optical receiver 124 may be contained within or coupled to electronics housing 120.

Retroreflector 130 may be disposed on hub 116 or shaft 114 of engine 110. Specular or semi-specular reflectors require the optical receiver 124 to be placed a certain distance from the optical emitting source 122 proportional to an incident angle on a surface being measured. In contrast, retroreflectors are optical devices which return incident radiant flux back to a source where an angle of incidence is within about plus or minus 60 degrees with sufficient radiant flux 140a for signal analysis, thus reducing constraints on placement angles and distances. Therefore, electronics housing 120 and/or optics housing 128 may be located within about plus or minus 60 degrees of retroreflector 130 to successfully emit radiant flux 140a toward retroreflector 130 and receive incident radiant flux 140b in turn. Compared to Lambertian reflectors (e.g., matte or diffuse reflectors), retroreflectors provide a significantly higher and more directed reflected radiant flux, allowing reduced power of optical emitting source 122 to be used. Retroreflectors are available in various formats, including, for example, corner cube or prismatic retroreflectors, glass bead retroreflectors, and full cube retroreflectors. Retroreflectors may be singular optical elements, or arrays thereof. For high temperature applications, retroreflector 130 may be fabricated from a metal or ceramic, while for lower temperature applications, retroreflector 130 may take the form of a polymer film which is adhered to a portion of engine 110 or another rotating component. Retroreflector 130 may be attached to hub 116 or shaft 114 of engine 110 of an aircraft or to other suitable components of the aircraft via any suitable technique such as adhesive, welding, friction-fit, atomic bonding, or the like. In aspects, retroreflector 130 may be a retroreflective feature machined directly into a surface of hub 116, shaft 114, or any other component of interest.

Retroreflector 130 may be sized based on factors such as intended application, a wavelength of radiant flux 140a, or an optical power of optical emitting source 122. Due to the increased intensity and optical power provided by retroreflector 130, retroreflector 130 is configured to reflect radiant flux 140a from optical emitting source 122 back to the source of emission of radiant flux 140a, that is, back to optical emitting source 122. Further, retroreflector 130 is configured to reflect radiant flux which is angled as far as about 60 degrees from a normal incidence angle of retroreflector 130. Additionally, depending upon emitted optical power, irradiance and angle incident upon the retroreflector 130, optical receiver 124 sensitivity, and wavelength, optical emitting source 122 may be separated by large distances from retroreflector 130 such that retroreflector 130 and optical emitting source 122 are configured to maintain a cooperative arrangement with one another to, for example, emit, reflect, and/or receive energy (e.g., light or radiant flux) from/to/between one another. In aspects, a distance between optical emitting source 122 and retroreflector 130 may be about 0.001 to 20 feet, though optical emitting source 122 and retroreflector 130 are configured to maintain the cooperative arrangement with one another when separated by distances exceeding several kilometers.

Once radiant flux 140a is emitted from optical emitting source 122 of electronics housing 120, radiant flux 140a interrogates retroreflector 130. Retroreflector 130 then reflects incident radiant flux 140b at a high intensity back toward electronics housing 120, and thereby toward optical receiver 124. Optical receiver 124 detects and transduces incident radiant flux 140b into an electrical signal to be analyzed by controller 200. Optical receiver 124 may include a singular optical transducer, or may include an array or plurality of optical transducers. Optical receiver 124 may include one or more avalanche photodiodes (APDs), one or more photodiodes, one or more photomultiplier tubes (PMTs), one or more photon counting APDs, one or more complementary metal oxide semiconductors (CMOS) imagers, one or more charge-coupled device (CCD) imagers, or the like. It is contemplated that optical receiver 124 may include any singular transducer or array of transducers. In aspects, optical receiver 124 may include a singular avalanche photodiode which, with or without combination of additional electronic components, converts received incident radiant flux 140b to an electrical signal. Once converted to an electrical signal, which may include a current or voltage reading or a time stamp, incident radiant flux 140b received by optical receiver 124 may be evaluated to determine a rotational speed of the component on which retroreflector 130 is disposed and/or to determine a starting point. In aspects, optical receiver 124 may count pulses of incident radiant flux 140b and controller 200 may store time intervals at which pulses occur.

Turning to FIG. 2A in particular, a schematic diagram of system 100 having electronics housing 120 integrated into engine 110 is illustrated. As shown, hub 116 may be attached to shaft 114, and retroreflector 130 may be disposed on a portion of hub 116. Electronics housing 120 may include both optical emitting source 122 and optical receiver 124, and may additionally include controller 200. Controller 200 may also be located in any other suitable location. Electronics housing 120 may be disposed within housing 112 of engine 110, and optical emitting source 122 and optical receiver 124 may face the portion of hub 116 on which retroreflector 130 is disposed. An emitting waveguide 126a may connect to optical emitting source 122 and may also be disposed on or within housing 112 of engine 110. Similarly, a receiving waveguide 126b may connect to optical receiver 124 and may be located on or within housing 112.

When engine 110 is operating, that is, when engine 110 rotates shaft 114 and hub 116, retroreflector 130 is moved out of a field of view of electronics housing 120. Therefore, when radiant flux 140a is emitted by optical emitting source 122, radiant flux 140a is not incident on retroreflector 130, and no incident radiant flux 140b is received by optical receiver 124. That is, no signal is generated when retroreflector 130 is out of the field of view. When hub 116 rotates such that retroreflector 130 is moved within an appropriate line of sight and angle of incidence of electronics housing 120, radiant flux 140a is emitted from optical emitting source 122 and reflected off of retroreflector 130 to be received by optical receiver 124 as incident radiant flux 140b. Incident radiant flux 140b is received by optical receiver 124 and subsequently transduced into a signal. Controller 200 then analyzes the data obtained by optical receiver 124 to determine a rotational speed of hub 116. Alternatively, or in addition, the data obtained by optical receiver 124 may be used to discern a starting point of rotation of hub 116. Both the determination of rotational speed and the location of a starting point may aid in synchronizing rotation of various components within the aircraft.

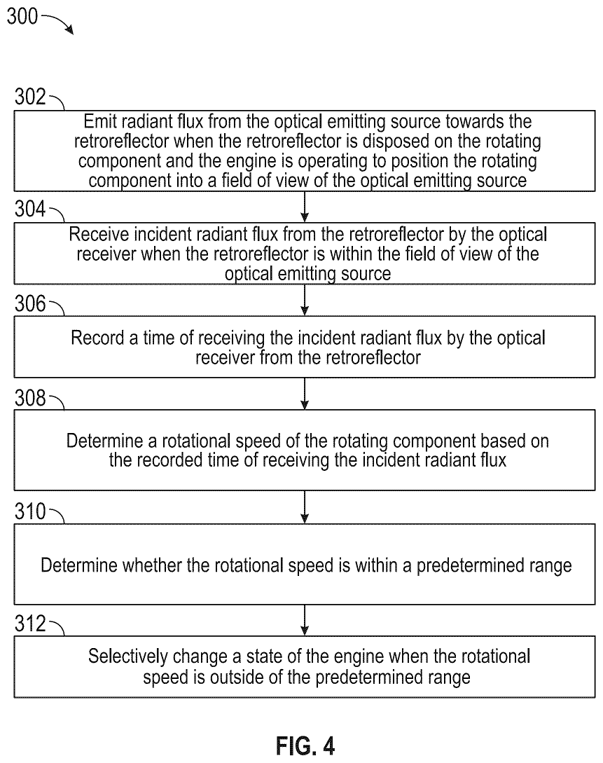

Due to the high intensity reflective capabilities of retroreflector 130, electronics housing 120 may be separated from engine 110 and retroreflector 130 by a large distance. In aspects, electronics housing 120 may be disposed a distance from engine 110. In such cases, a combination of waveguide 126 and optics housing 128 may be used to ensure that radiant flux 140a may properly reflect off retroreflector 130 at long ranges. Such a configuration may be used in open fan applications or applications in which electronics housing 120 may not be easily integrated in close proximity to retroreflector 130. FIG. 2B illustrates a schematic diagram of system 100 including optics housing 128, waveguide 126, and electronics housing 120 disposed a distance from engine 110. As shown, emitting waveguide 126a (or emitting fiber optic cable) may be coupled to optical emitting source 122, and receiving waveguide 126b (or receiving fiber optic cable) may be coupled to optical receiver 124. Emitting waveguide 126a and receiving waveguide 126b may be integrated into a single waveguide 126 bundle which is coupled to optics housing 128. Hub 116 of engine 110 includes retroreflector 130, and when engine 110 is powered on to rotate hub 116, optical emitting source 122 is caused to emit radiant flux 140a, which travels through emitting waveguide 126a and is projected toward retroreflector 130 by optics housing 128. When retroreflector 130 is within a line of sight, incident radiant flux 140b is reflected and travels through optics housing 128 and receiving waveguide 126b to be transduced by optical receiver 124. Controller 200 then evaluates a signal generated by incident radiant flux 140b received by optical receiver 124, and determines a rotational speed and/or starting point of hub 116, which may be analyzed to determine asynchronous rotation. This is explained in greater detail with regard to FIG. 4.

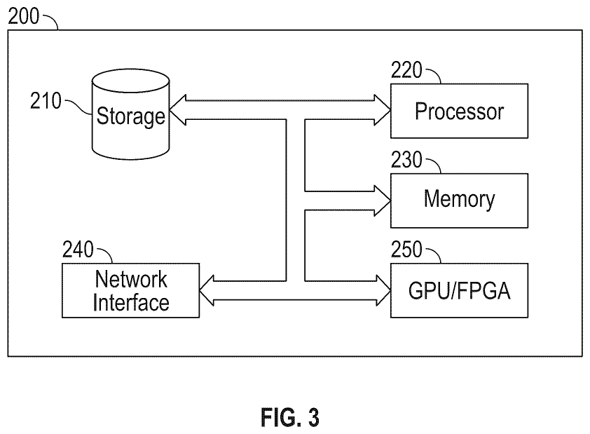

FIG. 3 illustrates that controller 200 includes a processor 220 connected to a computer-readable storage medium or a memory 230. The computer-readable storage medium or memory 230 may be a volatile type of memory, e.g., RAM, or a non-volatile type of memory, e.g., flash media, disk media, etc. In various aspects of the disclosure, the processor 220 may be another type of processor, such as a digital signal processor, a microprocessor, an ASIC, a graphics processing unit (GPU) 250, a field-programmable gate array (FPGA), or a central processing unit (CPU). In certain aspects of the disclosure, network inference may also be accomplished in systems that have weights implemented as memristors, chemically, or other inference calculations, as opposed to processors.

In aspects of the disclosure, the memory 230 can be random access memory, read-only memory, magnetic disk memory, magnetic non-volatile memory, solid-state memory, optical disc memory, and/or another type of memory. In some aspects of the disclosure, the memory 230 can be separate from the controller 200 and can communicate with the processor 220 through communication buses of a circuit board and/or through communication cables such as serial ATA cables or other types of cables. The memory 230 includes computer-readable instructions that are executable by the processor 220 to operate the controller 200. In other aspects of the disclosure, the controller 200 may include a network interface 240 to communicate with other computers or to a server. A storage device 210 may be used for storing data.

In aspects, an analytics engine (e.g., a machine learning model and/or classical analytics) may be configured to perform the determinations. The analytics engine includes a machine learning model. The machine learning model may be based on a deep learning network, a classical machine learning model, or combinations thereof.

With regard to FIG. 4, a controller 200 or a user device, including, for example, a mobile device, an IoT device, or a server system, are configured to effectuate a method 300. Method 300 may be employed during test, development, and/or during flight or operation of an aircraft or components thereof. Prior to initiating method 300, or at any point during or after implementation of method 300, a predetermined range for rotational speed may be stored, for example, on the memory 230 so that the predetermined range is accessible by controller 200. The predetermined range may be an acceptable range of rotational speeds for a first component, and may be based off of and/or include a rotational speed of one or more other components (e.g., a second rotating component), with which the first component is to be synchronized.

At a first step 302, optical emitting source 122 emits radiant flux 140a toward retroreflector 130 disposed on a rotating component operably connected to engine 110 when engine 110 is operating to position the rotating component into a field of view of optical emitting source 122. For example, retroreflector 130 may be disposed on hub 116 of engine 110. Optical emitting source 122 may be connected to a waveguide 126 or optics housing 128, which may direct radiant flux toward hub 116, or other relevant rotating component. When retroreflector 130 is rotated away from optical emitting source 122 (or waveguide 126 or optics housing 128), radiant flux 140a does not encounter retroreflector 130, and thus no incident radiant flux 140b is reflected off of retroreflector 130 to be received by optical receiver 124 and no signal is generated. When retroreflector 130 turns toward optical emitting source 122 (or waveguide 126 or optics housing 128), radiant flux 140a interrogates retroreflector 130 and incident radiant flux 140b is reflected back toward optical emitting source 122, which is operably disposed proximal to optical receiver 124. Thus, at a second step 304, incident radiant flux 140b is received by optical receiver 124 when retroreflector 130 is within the field of view of optical emitting source 122. Optical receiver 124 transduces incident radiant flux 140b into an electrical signal.

At a third step 306, a time of receiving incident radiant flux 140b by optical receiver 124 from retroreflector 130 is recorded and stored by controller 200. At a fourth step 308, a rotational speed of the rotating component, here, hub 116, is determined based on the recorded time of the incident radiant flux 140b received by optical receiver 124. By tracking electrical signal pulses generated based on incident radiant flux 140b, a time interval between successive pulses may be measured. Rotational speed may then be calculated based on the time interval. At a fifth step 310, the rotational speed is compared to a predetermined range, which may be stored, for example, on memory. If the rotational speed is within the predetermined range, engine 110 may continue operating normally. If the rotational speed is outside of the predetermined range, potential asynchronous rotation is identified in hub 116. Once asynchronous rotation is identified, at a sixth step 312, a state of engine, or one or more components thereof 110 is changed. Controller 200 may cause engine 110 to start, to stop, change speed, change power, change voltage, change current, change direction, etc., and/or combinations thereof to enable further analysis, repair, and/or replacement of engine 110 or one or more components thereof (e.g., hub 116) and/or to initiate further testing. For example, if the rotational speed of hub 116 is below the predetermined range, power to engine 110 may be increased to increase the rotational speed of hub 116. As previously noted, the predetermined range may be set based upon an expected rotational speed of the rotating component to be measured or upon a rotational speed of another component, if the component to be measured and the other component are expected to have the same or similar rotational speeds.

In aspects, retroreflector 130, optical emitting source 122, and optical receiver 124 may be used to determine a starting point of the rotating component (e.g., hub 116). Retroreflector 130 may be placed on hub 116 or another rotating component to mark a specific position. Upon radiant flux 140a being reflected off retroreflector 130 and incident radiant flux 140b being received by optical receiver 124, controller 200 determines each electrical signal pulse as being an index pulse which indicates a starting point of each revolution of hub 116. Using the recorded time at which the index pulse occurs, other components may be synchronized to rotate or to undergo specific actions at the starting point of the hub 116. In aspects, the starting point of hub 116 may be used to synchronize measurements taken from sensors within system 100. For example, sensor data, such as accelerometer data used to record vibrations within engine 110, may be recorded relative to the time interval of the starting point of hub 116. The high-intensity capabilities of retroreflector 130 allow for precise location of the starting point as well as highly accurate signal triggering at low as well as high rotational speeds, thus permitting a more accurate determination of rotational speed and more accurate synchronization of the components of the aircraft.

In aspects, controller 200 may cause system 100 to output an alert indicating the state or condition of engine 110 (or one or more components thereof) based on the determination performed in fifth step 310. The alert may be an audio, visual, and/or haptic alert. A visual alert may be displayed on an imaging device and/or a mobile device, such as a smartphone, tablet, laptop, e-reader, smartwatch, and/or virtual reality (VR) headset. In aspects, system 100 may output a visual alert to a display showing a portion of engine 110 (or one or more components thereof) which is deformed. The visual alert may include still images and/or videos, which a user may replay and review for further analysis. In aspects, the user may be able to view a 360-degree model replaying the images of engine 110 (or one or more components thereof), which the controller and/or imaging device may generate, and which may be configured to illustrate a location of an abnormality of the engine and/or one or more rotating components. An audio alert may be output via a speaker and may indicate asynchronous rotation of hub 116 with one or more other components. The audio alert may be a ringing, chirping, beeping, and/or other loud noise configured to alert a user. In another example, system 100 may output haptic feedback to a mobile device, such as a vibrational feedback, force feedback, and/or surface haptics.

In aspects, the controller 200 of system 100 may cause system 100 to output performance metrics, characteristics, and/or alerts. For example, after alerting the user of identified asynchronous rotation, a display may indicate details regarding an exact rotational speed of engine 110 or one or more components thereof at the time of occurrence of the asynchronous rotation. In aspects, in response to identifying asynchronous rotation at fourth step 308, controller 200 may change a torque, a thrust, and/or a power demand of engine 110 to rectify the asynchronous rotation.

In aspects, artificial intelligence (AI) such as machine learning (ML) algorithms may be used to enhance monitoring and prevention asynchronous rotation of components of engine 110 by improving the accuracy, efficiency, and/or robustness of the analysis process. For example, a convolutional neural network (CNN) can be trained to detect and analyze component movement in high-speed video footage. This provides a benefit over traditional tracking software, as AI such as a CNN can handle complex motion patterns and occlusions more effectively than present methods while filtering out noise. Moreover, an ML algorithm can automate the extraction of relevant features from high-speed footage, such as detecting a starting point and determining whether functions of other components are synchronized to the starting point, thereby reducing the need for manual intervention and increasing the consistency of the analysis.

Various additional implementations of AI with retroreflective enhanced high-speed imaging are contemplated and within the scope of this disclosure, including but not limited to ML, deep learning (e.g., recurrent neural networks (RNNs), generative adversarial networks (GANs), and/or computer vision algorithms.

The phrases “in an aspect,” “in aspects,” “in various aspects,” “in some aspects,” or “in other aspects” may each refer to one or more of the same or different aspects in accordance with this disclosure. A phrase in the form “A or B” means “(A), (B), or (A and B).” A phrase in the form “at least one of A, B, or C” means “(A); (B); (C); (A and B); (A and C); (B and C); or (A, B, and C).”

In one or more examples, the described techniques may be implemented in hardware, software, firmware, or any combination thereof. If implemented in software, the functions may be stored as one or more instructions or code on a computer-readable medium and executed by a hardware-based processing unit. Computer-readable media may include non-transitory computer-readable media, which corresponds to a tangible medium such as data storage media (e.g., RAM, ROM, EEPROM, flash memory, or any other medium that can be used to store desired program code in the form of instructions or data structures and that can be accessed by a computer).

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor” as used herein may refer to any of the foregoing structure or any other physical structure suitable for implementation of the described techniques. Also, the techniques could be fully implemented in one or more circuits or logic elements.

Further aspects of the present disclosure are provided by the subject matter of the following clauses.

A system for preventing asynchronous rotation in aircraft components includes an optical emitting source, an optical receiver, and a retroreflector configured to be disposed on a rotating component operably connected to an engine of an aircraft. The system emits radiant flux from the optical emitting source towards the retroreflector when the retroreflector is disposed on the rotating component and the engine is operating to position the rotating component into a field of view of the optical emitting source; receives incident radiant flux from the retroreflector by the optical receiver when the retroreflector is within the field of view of the optical emitting source; records a time of receiving the incident radiant flux by the optical receiver from the retroreflector; determines a rotational speed of the rotating component based on the recorded time of receiving the incident radiant flux; determines whether the rotational speed is within a predetermined range; and selectively changes a state of the engine when the rotational speed is outside of the predetermined range.

The system according to the preceding clause, wherein the predetermined range includes a rotational speed of a second rotating component.

The system according to any preceding clause, wherein the rotating component is a hub of the engine.

The system according to any preceding clause, wherein the instructions, when executed by the processor further cause the system to: designate the recorded time of receiving the incident radiant flux as a starting point of revolution of the rotating component.

The system according to the preceding clause, wherein the instructions, when executed by the processor further cause the system to: change a state of a second component at a time coinciding with the starting point of revolution of the rotating component.

The system according to any preceding clause, wherein the optical emitting source and the optical receiver are disposed within at least one of an electronics housing or an optics housing.

The system according to the preceding clause, wherein at least one of the electronics housing or the optics housing is located within about 60 degrees of a normal incidence angle of the retroreflector.

The system according to any preceding clause, wherein the optical receiver includes at least one of a photodiode, a photomultiplier tube (PMT), an avalanche photodiode (APD) a photon counting APD, a complementary metal oxide semiconductor (CMOS) imager, or a charge-coupled device (CCD) imager.

The system according to any preceding clause, wherein the instructions, when executed by the processor further cause the system to: change the state of the engine by changing at least one of a torque, a thrust, or a power demand of the engine.

The system according to any preceding clause, wherein the optical emitting source includes an emitting waveguide for containing and transmitting the radiant flux from an optical emitting transducer, and wherein the optical receiver includes a receiving waveguide for receiving and transmitting the incident radiant flux to an optical detecting transducer.

The system according to the preceding clause, wherein the emitting waveguide and the receiving waveguide are coupled into a waveguide bundle.

The system according to the preceding clause, wherein an optics housing is integrated into an end of the waveguide bundle.

A processor-implemented method for preventing asynchronous rotation in aircraft components comprises: emitting radiant flux from an optical emitting source towards a retroreflector when the retroreflector is disposed on a rotating component operably connected to an engine and the engine is operating to position the rotating component into a field of view of the optical emitting source; receiving an incident radiant flux from the retroreflector by the optical receiver when the retroreflector is within the field of view of the optical emitting source; recording a time of receiving the incident radiant flux by the optical receiver from the retroreflector; determining a rotational speed of the rotating component based on the recorded time of receiving the incident radiant flux; determining whether the rotational speed is within a predetermined range; and selectively changing a state of the engine when rotational speed is outside of the predetermined range.

The processor-implemented method according to the preceding clause, wherein the predetermined range includes a rotational speed of a second rotating component.

The processor-implemented method according to any preceding clause, wherein the rotating component is a hub of the engine.

The processor-implemented method according to any preceding clause, further including: designating the recorded time of receiving the incident radiant flux as a starting point of revolution of the rotating component.

The processor-implemented method according to the preceding clause, further including: changing a state of a second component of the aircraft at a time coinciding with the starting point of revolution of the rotating component.

The processor-implemented method according to any preceding clause, wherein the optical emitting source and the optical receiver are disposed within at least one of an electronics housing or an optics housing.

The processor-implemented method according to the preceding clause, wherein at least one of the electronics housing or the optics housing is located within about 60 degrees of a normal incidence angle of the retroreflector.

The processor-implemented method according to any preceding clause, wherein the optical receiver includes at least one of a photodiode, a photomultiplier tube (PMT), an avalanche photodiode (APD) a photon counting APD, a complementary metal oxide semiconductor (CMOS) imager, or a charge-coupled device (CCD) imager.

The processor-implemented method according to any preceding clause, further including changing the state of the engine by changing at least one of a torque, a thrust, or a power demand of the engine.

An aircraft including a system for preventing asynchronous rotation in aircraft components, the aircraft including an electronics housing, a retroreflector, a processor, and a memory. The electronics housing is disposed on the aircraft, and includes an optical emitting source configured to provide radiant flux and an optical receiver. The retroreflector is configured to be disposed on a rotating component operably connected to an engine of the aircraft. The memory includes instructions stored thereon, which, when executed by the processor cause the system to: emits radiant flux from the optical emitting source towards the retroreflector when the retroreflector is disposed on the rotating component and the engine is operating to position the rotating component into a field of view of the optical emitting source; receives incident radiant flux from the retroreflector by the optical receiver when the retroreflector is within the field of view of the optical emitting source; records a time of receiving the incident radiant flux by the optical receiver from the retroreflector; determines a rotational speed of the rotating component based on the recorded time of receiving the incident radiant flux; determines whether the rotational speed is within a predetermined range; and selectively changes a state of the engine when the rotational speed is outside of the predetermined range.

The aircraft according to the preceding clause, wherein the predetermined range includes a rotational speed of a second rotating component.

Persons skilled in the art will understand that the structures and methods specifically described herein and shown in the accompanying figures are non-limiting exemplary aspects, and that the description, disclosure, and figures should be construed merely as exemplary of aspects. It is to be understood, therefore, that this disclosure is not limited to the precise aspects described, and that various other changes and modifications may be effectuated by one skilled in the art without departing from the scope or spirit of the disclosure. Additionally, the elements and features shown or described in connection with certain aspects may be combined with the elements and features of certain other aspects without departing from the scope of this disclosure, and that such modifications and variations are also included within the scope of this disclosure. Accordingly, the subject matter of this disclosure is not limited by what has been particularly shown and described.

What is claimed is:

1. A system for preventing asynchronous rotation in aircraft components, the system comprising:
an optical emitting source configured to provide radiant flux;
an optical receiver configured to detect incident radiant flux;
a retroreflector configured to be disposed on a rotating component operably connected to an engine of an aircraft;
a processor; and
a memory, including instructions stored thereon, which, when executed by the processor cause the system to:
emit radiant flux from the optical emitting source towards the retroreflector when the retroreflector is disposed on the rotating component and the engine is operating to position the rotating component into a field of view of the optical emitting source;
receive incident radiant flux from the retroreflector by the optical receiver when the retroreflector is within the field of view of the optical emitting source;
record a time of receiving the incident radiant flux by the optical receiver from the retroreflector;
determine a rotational speed of the rotating component based on the recorded time of receiving the incident radiant flux;
determine whether the rotational speed is within a predetermined range; and
selectively change a state of the engine when the rotational speed is outside of the predetermined range.

2. The system according to claim 1, wherein the predetermined range includes a rotational speed of a second rotating component.

3. The system according to claim 1, wherein the rotating component is a hub of the engine.

4. The system according to claim 1, wherein the instructions, when executed by the processor further cause the system to:
designate the recorded time of receiving the incident radiant flux as a starting point of revolution of the rotating component.

5. The system according to claim 4, wherein the instructions, when executed by the processor further cause the system to:
change a state of a second component at a time coinciding with the starting point of revolution of the rotating component.

6. The system according to claim 1, wherein the optical emitting source and the optical receiver are disposed within at least one of an electronics housing or an optics housing.

7. The system according to claim 6, wherein at least one of the electronics housing or the optics housing is located within about 60 degrees of a normal incidence angle of the retroreflector.

8. The system according to claim 1, wherein the optical receiver includes at least one of a photodiode, a photomultiplier tube (PMT), an avalanche photodiode (APD) a photon counting APD, a complementary metal oxide semiconductor (CMOS) imager, or a charge-coupled device (CCD) imager.

9. The system according to claim 1, wherein the instructions, when executed by the processor further cause the system to:
selectively change the state of the engine by changing at least one of a torque, a thrust, or a power demand of the engine.

10. A processor-implemented method for preventing asynchronous rotation in aircraft components, the method comprising:
emitting radiant flux from an optical emitting source towards a retroreflector when the retroreflector is disposed on a rotating component operably connected to an engine and the engine is operating to position the rotating component into a field of view of the optical emitting source;
receiving an incident radiant flux from the retroreflector by an optical receiver when the retroreflector is within the field of view of the optical emitting source;
recording a time of receiving the incident radiant flux by the optical receiver from the retroreflector;
determining a rotational speed of the rotating component based on the recorded time of receiving the incident radiant flux;
determining whether the rotational speed is within a predetermined range; and
selectively changing a state of the engine when rotational speed is outside of the predetermined range.

11. The processor-implemented method according to claim 10, wherein the predetermined range includes a rotational speed of a second rotating component.

12. The processor-implemented method according to claim 10, wherein the rotating component is a hub of the engine.

13. The processor-implemented method according to claim 10, further comprising:
designating the recorded time of receiving the incident radiant flux as a starting point of revolution of the rotating component.

14. The processor-implemented method according to claim 13, further comprising:
changing a state of a second component at a time coinciding with the starting point of revolution of the rotating component.

15. The processor-implemented method according to claim 10, wherein the optical emitting source and the optical receiver are disposed within at least one of an electronics housing or an optics housing.

16. The processor-implemented method according to claim 15, wherein at least one of the electronics housing or the optics housing is located within about 60 degrees of a normal incidence angle of the retroreflector.

17. The processor-implemented method according to claim 10, wherein the optical receiver includes at least one of a photodiode, a photomultiplier tube (PMT), an avalanche photodiode (APD) a photon counting APD, a complementary metal oxide semiconductor (CMOS) imager, or a charge-coupled device (CCD) imager.

18. The processor-implemented method according to claim 10, further comprising:
selectively changing the state of the engine by changing at least one of a torque, a thrust, or a power demand of the engine.

19. An aircraft including a system for preventing asynchronous rotation in aircraft components, the aircraft comprising:
an electronics housing disposed on the aircraft, the electronics housing including an optical emitting source configured to provide radiant flux and an optical receiver;
a retroreflector configured to be disposed on a rotating component operably connected to an engine of the aircraft;
a processor; and
a memory, including instructions stored thereon, which, when executed by the processor cause the system to:
emit radiant flux from the optical emitting source towards the retroreflector when the retroreflector is disposed on the rotating component and the engine is operating to position the rotating component into a field of view of the optical emitting source;
receive incident radiant flux from the retroreflector by the optical receiver when the retroreflector is within the field of view of the optical emitting source;
record a time of receiving the incident radiant flux by the optical receiver from the retroreflector;
determine a rotational speed of the rotating component based on the recorded time of receiving the incident radiant flux;
determine whether the rotational speed is within a predetermined range; and
selectively change a state of the engine when the rotational speed is outside of the predetermined range.

20. The aircraft of claim 19, wherein the predetermined range includes a rotational speed of a second rotating component.
